(19) United States
(12) Patent Application Publication
(10) Pub. No.: US 2002/0007349 A1
(43) Pub. Date: Jan. 17, 2002

(54) Electronic reading system with copying capabilities

(76) Inventor: Henry C. Yuen, Pasadena, CA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/873,888

(22) Filed: Jun. 4, 2001

Related U.S. Application Data
(60) Provisional application No. 60/209,115, filed on Jun. 2, 2000.
(60) Provisional application No. 60/209,092, filed on Jun. 2, 2000.

(51) Int. Cl. G06F 17/60

(52) U.S. Cl. 705/52; 705/26

(57) ABSTRACT

Literary material for value is downloaded into an eBook or other electronic device. The method of the invention includes the steps of user-selecting a potion of the material for special treatment, discarding the remaining material, and keeping track the portion retained relative to the discarded material. The non-selected material may be discarded by purging or otherwise transferring the material without leaving a copy in the device. The step of keeping track of the portion retained may be used for billing purposes, and the user may be alerted in advance as to the anticipated charge, amount “copied,” copyright owner, and other characteristics. The billing may be based upon time of use or quantity of the retained material. According to a different embodiment of the invention, a geographic code may stored which reflects such geographic regions that the device is “attached” to. This may be the geographic area that the device was purchased, or that the device has been authorized to receive content in. The latter may be the location of the device at the time of the attempted downloading, or a combination of such factors. If there is mismatch between the “type” of device and the copyright holder or other factor(s), the content will not be successfully downloaded to the device according to the invention.

### REFERENCE TO RELATED APPLICATION

This application claims priority from U.S. provisional patent application Ser. Nos. 60/209,115 and 60/209,092, both filed Jun. 2, 2000, the entire contents of both being incorporated herein by reference.

### FIELD OF THE INVENTION

The present invention relates generally to electronic books. More particularly, the invention relates to an electronic book, magazine or other form of reading system having copying capabilities for added functionality.

### BACKGROUND OF THE INVENTION

Electronic books are becoming a technological and economical reality. However, electronic books or e-books continue to be compared with conventional books on factors such as readability and weight, thereby slowing acceptance. Other concerns include problems associated with connecting to on-line services to receive downloads.

Inventions directed to electronic book technology date back to the 1970s. According to U.S. Pat. No. 4,159,417, the contents of a book, magazine or the like, are digitally encoded onto a memory, and the memory is removably insertable into a portable book-like apparatus whereby the encoded information can be displayed on a screen of the apparatus. Although the specific embodiment described is a holographic memory system, this patent also contemplates the use of other digital, nonvolatile memories, including microfilm, graphically encoded cards or discs, magnetic-bubble memories, as well as other optical or electronic media.

Over the last two decades, numerous other patents have been awarded which describe improvements in fundamental ebook technology, including advances in data communications and human interaction. U.S. Pat. No. 5,534,888 describes a hinged, book-like housing with electronics including a processor for manipulating data, a memory for data storage, an input for entering data, and an output for removing data. A plurality of display pages are provided which may be turned for a continual flow of data, text, video, and graphics.

When the ebook is closed, however, certain electronic functions may remain active, thereby providing a user with a variety of communications accessories, including a paging system. For example, the plurality of displays may be read, as well as scrolled using a plurality of function keys, to identify textual materials such as incoming pages, cataloging or storing received paging messages, titles stored materials, and the like. The central processor is also networked, so that data or information can be downloaded or uploaded between a network using a variety of methods such as a direct electrical connection, a wireless link having a radio receiver and a radio transmitter for paging and cellar communications, or the like.

Although the electronic book described in U.S. Pat. No. 5,534,888 is provided with certain communications features, both the disclosed hardware and attendant functionality are limited in scope. The need remains, therefore, for an ebook having more advanced capabilities. In particular, there are times that a user may wish to download certain content on a loan basis, such as library materials. The user may also want to capture portion or all of such content for permanent usage. At the same time, downloading may be subject to geographic considerations. Such advances would hopefully defeat comparisons with conventional books and justify the higher upfront investment required for the ebook.

### SUMMARY OF THE INVENTION

Broadly, this invention permits certain material to be downloaded into an eBook or other electronic device, wherein such material may not be needed—or not be allowed—for longer than a certain period of time. For nomenclature purposes only, these materials are considered “loan materials,” even though certain materials may legitimately be contained in the eBook for an indefinite period of time, but where the owner only wants to store a portion of such materials at a given time.

A method of retaining certain information from material downloaded to an electronic book or other computing device according to the invention includes the steps of user-selecting a potion of the material for special treatment, discarding the remaining material, and keeping track the portion retained relative to the discarded material. The non-selected material may be discarded by purging or otherwise transferring the material without leaving a copy in the device.

The step of keeping track of the portion retained may be used for billing purposes, and the user may be alerted in advance as to the anticipated charge, amount “copied,” copyright owner, and other characteristics. The billing may be based upon time of use or quantity of the retained material.

According to a different embodiment of the invention, a geographic code may stored which reflects such geographic regions that the device is “attached” to. This may be the geographic area that the device was purchased, or that the device has been authorized to receive content in. The latter may be the location of the device at the time of the attempted downloading, or a combination of such factors. If there is mismatch between the “type” of device and the copyright holder or other factor(s), the content will not be successfully downloaded to the device according to the invention. Further, there may be a message informing the user of the lack of rights, and the user may additionally be referred to a method which will provide him or her with the legitimate copy of the same, similar or related contents.

### BRIEF DESCRIPTION OF THE DRAWINGS

FIG. 1 is a drawing of a preferred embodiment of the invention, wherein a portion of a book is “copied” by the user of an electronic book and charged for such usage.

### DETAILED DESCRIPTION OF THE INVENTION

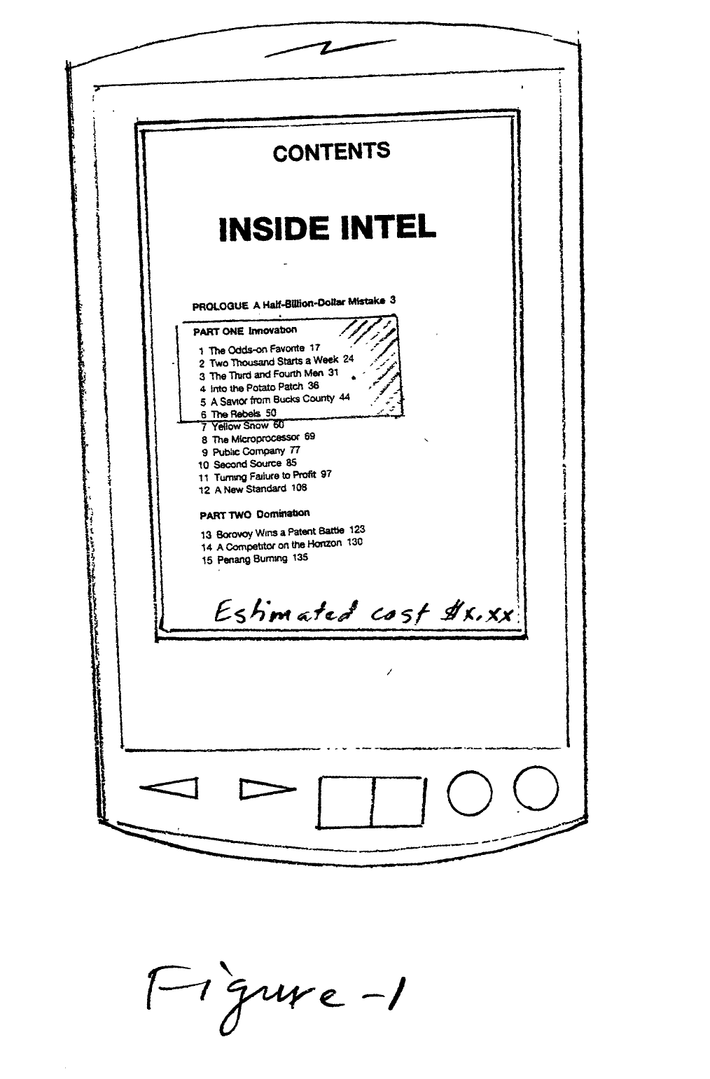

This invention allows the retention of such material by a user activated “copying” function. This function may be implemented in a variety of ways enabling a user to specify that portion which is to be retained. A specific example is an eBook device wherein certain material is downloaded. In the embodiment of FIG. 1, the user has highlighted a portion of such material, causing the material to be “copied” or marked for special treatment. The estimated cost of the material is provided in a window, and the user is immediately or later billed, or an existing account is debited for such usage. The remaining material may be “returned” (purged or transferred without leaving a copy in the device).

This embodiment may include a metering system to keep track of all materials copied which may be used for extolling a “copying charge” or “chapter charge,” and communications circuitry for communicating such metering information to a remote device, such as a central server, so as to implement a charging scheme. This aspect of the system may further present information on the charges to the user, or keep a running tab on all copies that has been charged. Such charges may or may not be time-dependent, as well as quantity and material dependent.

Although the embodiment just described references an electronic book, the invention I applicable to non-eBooks type devices, including general-purpose computing devices storing contents. The invention is also facilitates different methods of specifying the material to be copied. In particular, highlighting, specifying pages, specifying chapters, specifying paragraphs, or specifying specific graphs or portions of video may be used.

Various alternative metering systems may be used to keep track of the material stored, and such system(s) may reside in a remote device or in the local device, or part in the remote device and part in the local device. As a further option, an automatic “search and copy” function may be implemented wherein, upon input of certain criteria (such as keywords or dates or authors or reference(s)), the various portions corresponding to such criteria will be automatically “copied,” or presented for selection to be “copied.” Such a function is particularly relevant to situations involving library research.

It may be the case that the distribution of certain contents may have geographic limitations due to copyright or other conditions, including a situation where different parties possess rights in different geographic areas. For example, the right to publish a novel in the U.S. may reside with company A, while the right to publish a novel in U.K. may reside with company B. By aligning certain characteristic of the material such as copyright ownership, with geographic area, utility would be further enhanced.

According to this embodiment of the invention, a geographic code may stored which reflects such geographic regions that the device is “attached” to. This may be the geographic area that the device was purchased, or that the device has been authorized to receive content in. The latter may be the location of the device at the time of the attempted downloading, or a combination of such factors. The geographic “marker” is meant to be specific to the device, and may or may not be dependent on the actual geographical location it is in.

As an example of the invention, an eBook purchased in the U.S. will be used. In this example, it is also assumed that the device has a U.S. “marker.” Assume further that the user accesses an Internet server which distributes contents by a U.K. rights holder, and that such rights do not extend to “U.S. devices.” “U.S devices” may be defined in a variety of ways, including devices purchased in the U.S., or devices located in the U.S., or a combination of the two.

Given the mismatch between the “type” of device and the U.K. rights holder, the content will not be successfully downloaded to the device according to the invention. Further, there may be a message information the user of the lack of rights, and the user may additionally be referred to a method which will provide him or her with the legitimate copy of the same, similar or related contents.

This embodiment of the invention may be extended in various ways, including situations where the geographical location may be certain conditions such as membership, school districts, school enrollment or other communities. The invention is also applicable to situations where there is a discrimination means of identifying the various rights holders, and automatically connecting, assigning or allocating such content requests to such proper rights holders. The method is further applicable to situations where different prices, taxes, tolls or fees are automatically applied as a function of the geographic marker and the content to be retrieved, as well as in situations where the geographic market information may be stored remotely outside of the device, as well as within the device.

I claim:

1. A method of retaining certain information from material downloaded to an electronic book or other computing device, comprising the steps of:
user-selecting a potion of the material for special treatment;
discarding the remaining material; and
monitoring the portion retained relative to the discarded material.

2. The method of claim 1, wherein the remaining material is discarded by purging or otherwise transferring the material without leaving a copy in the e-book.

3. The method of claim 1, wherein the step of monitoring the portion retained for billing purposes.

4. The method of claim 3, wherein billing is based upon time of use or quantity of the retained material.

5. The method of claim 1, further including the steps of:
providing a code indicative of an authorized geographic region or regions;
requesting a download having a geographical significance into the e-book;
referring to the code to see of the e-book is authorized to receive the download; and
blocking the download if the e-book is not authorized.

6. The method of claim 5, wherein the code is related to the geographic area wherein the e-book was purchased or an area wherein the device has been authorized to receive particular material content.
